(19) United States
(12) Patent Application Publication
(10) Pub. No.: US 2025/0279082 A1
(43) Pub. Date: Sep. 4, 2025

(54) ACTIVE NOISE CANCELLATION USING DEEP NEURAL NETWORK

(71) Applicant: SKYWORKS SOLUTIONS, INC., Irvine, CA (US)

(72) Inventors: Alireza BAYESTEHTASHK, Vancouver, WA (US); Amit KUMAR, Portland, OR (US); Michael Jon WURTZ, Lake Oswego, OR (US)

(21) Appl. No.: 19/067,890

(22) Filed: Mar. 1, 2025

Related U.S. Application Data
(60) Provisional application No. 63/560,333, filed on Mar. 1, 2024.

(51) Int. Cl. G10K 11/178

(52) U.S. Cl. CPC G10K 11/17813; G10K 11/17853; G10K 11/17881; G10K 2210/3038

(57) ABSTRACT

An active noise cancellation system can include an input node for receiving a noise signal, an output node for providing an anti-noise signal, and one or more blocks each configured to provide a transfer function between its input and output, with the block being further configured to be capable of having its transfer function estimated by a deep neural network framework. Such an active noise cancellation system can be supported by a computation engine that can be implemented on a system-on-chip device which in turn can be included in an audio device such as a headset.

### CROSS-REFERENCE TO RELATED APPLICATION(S)

This application claims priority to U.S. Provisional Application No. 63/560,333 filed Mar. 1, 2024, entitled ACTIVE NOISE CANCELLATION USING DEEP NEURAL NETWORK, the disclosure of which is hereby expressly incorporated by reference herein in its respective entirety.

### BACKGROUND

### Field

The present disclosure relates to circuits, devices and methods for active noise cancellation using deep neural network.

### Description of the Related Art

In many audio applications, undesirable noise content can be canceled or reduced in a sound signal being processed such that sound delivered to a listener has a reduced amount of noise. However, reduction of such noise may also impact the quality of desirable content in the sound signal.

### SUMMARY

In accordance with a number of implementations, the present disclosure relates to an active noise cancellation system that includes an input node for receiving a noise signal and an output node for providing an anti-noise signal. The active noise cancellation system further includes one or more blocks each configured to provide a transfer function between its input and output, the block further configured to be capable of having its transfer function estimated by a deep neural network framework.

In some embodiments, each block can include a filter. In some embodiments, the filter can be configured as a finite impulse response filter or an infinite impulse response filter.

In some embodiments, the block can include a feedforward block.

In some embodiments, the block can include a feedback block. In some embodiments, the transfer function of the feedback block can be estimated based on linear and ideal speaker conditions. In some embodiments, the transfer function of the feedback block can be estimated with a condition including nonlinearity in a signal path.

In some embodiments, the one or more blocks can include a feedforward block and a feedback block. In some embodiments, each of the feedforward and feedback blocks can have its transfer function estimated by a separate deep neural network framework. In some embodiments, the feedforward and feedback blocks can have their transfer functions estimated by a common deep neural network framework.

In some embodiments, the active noise cancellation system can further include a computation engine configured to support the deep neural network framework. In some embodiments, the computation engine can include a biquad engine configured to perform biquad filter computations. In some embodiments, the computation engine can include a multiply-accumulate engine configured to perform multiply-accumulate computations.

In some embodiments, the computation engine can be part of a system-on-chip device. In some embodiments, the system-on-chip device can further include a digital signal processing circuit that includes the one or more blocks.

In some implementations, the present disclosure relates to a chip that includes a substrate and an active noise cancellation circuit implemented on the substrate. The active noise cancellation circuit includes an input node for receiving a noise signal and an output node for providing an anti-noise signal. The active noise cancellation circuit further includes one or more blocks each configured to provide a transfer function between its input and output. The block is further configured to be capable of having its transfer function estimated by a deep neural network framework.

In some embodiments, the chip can be configured as a system-on-chip. In some embodiments, the system-on-chip can further include a computation engine configured to support the deep neural network framework. In some embodiments, the system-on-chip device can further include a digital signal processing circuit that includes the one or more blocks.

In some implementations, the present disclosure relates to an audio device that includes an input circuit for receiving an input signal, a speaker for producing sound waves based on an output signal corresponding to the input signal, and an audio circuit configured to process the electrical signal and generate the output signal. The audio device further includes an active noise cancellation circuit having an input node for receiving a noise signal and an output node for providing an anti-noise signal. The active noise cancellation circuit further includes one or more blocks each configured to provide a transfer function between its input and output, with the block being further configured to be capable of having its transfer function estimated by a deep neural network framework.

In some embodiments, the audio device can further include one or more sensors configured to provide information related to the noise signal. The one or more sensors can include a microphone implemented to capture noise outside of the audio device and/or a microphone implemented to capture residual noise present with the sound waves produced from the speaker.

In some embodiments, the audio device can be a headset or an earbud. In some embodiments, the audio device can be a wireless device or a wired device.

In some implementations, the present disclosure relates to a method for cancelling noise. The method includes receiving a noise signal and generating an anti-noise signal with one or more blocks each providing a transfer function response between its input and output, with the providing of the transfer function response including estimating by a deep neural network framework.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows a diagram of a typical active noise cancellation (ANC) system.

FIG. 2 depicts a representation of second order sections as cascaded recurrent neural network with linear activation.

FIG. 3 shows an ANC architecture that can be implemented with a technique where combined estimation of feedforward (FF) and feedback (FB) filters are achieved simultaneously.

FIG. 4 shows an example of a headset system-on-chip (SoC) that includes a real-time acoustic processor (RAP) engine which can be configured to provide some or all of real-time audio processing as described herein.

FIG. 5 shows a block diagram of an architecture that can be implemented in the RAP engine of FIG. 4.

FIG. 6 shows a result of an experiment performed where a deep neural network (DNN) framework as described herein was utilized.

FIG. 7 shows the root mean square (RMS) of received noise for a manually designed FB filter and a DNN-based FB filter.

FIG. 8 shows a result of an experiment where a DNN-based framework was utilized to approximate a feedback (FB) filter when a speaker exhibits nonlinearity.

FIG. 9 shows that in some embodiments, an audio processor having one or more features as described herein can be implemented on a chip.

FIG. 10 shows that in some embodiments, an audio processor having one or more features as described herein can be included in an audio device.

### DETAILED DESCRIPTION OF SOME EMBODIMENTS

The headings provided herein, if any, are for convenience only and do not necessarily affect the scope or meaning of the claimed invention.

In many applications, audio devices such as headsets or earbuds, including wireless versions thereof, allow a listener to be immersed in music or engage in conversations. However, alongside intended audio signals, one often encounters unwanted noise from the surroundings. Such ambient noise can disrupt the listening experience and detract from the clarity of the desired audio content.

One approach for mitigating the impact of this unwanted noise is through passive noise cancellation. This method involves designing a closed enclosure around the ear, incorporating ear pads to envelop the ear, and/or ensuring a snug fit to minimize the transmission of surrounding noise to the ear.

Passive noise cancellation typically excels in attenuating high-frequency noise but faces challenges in effectively addressing low-frequency noise. Further, achieving a consistently optimal fit across various users can be demanding, and over time, the quality of the ear pad fit may degrade, potentially compromising the effectiveness passive noise cancellation performance. Furthermore, customization of passive enhancement can be severely limited due to its reliance on physical design constraints.

Another approach for mitigating the impact of unwanted noise is through active noise cancellation (ANC). This method typically involves employing an additional layer of technology alongside passive methods. ANC technique can involve integrating speakers inside an earcup not only to play the desired signal but also to emit an anti-noise signal. When combined with the leaked and residual noise from the passive layer, this anti-noise signal effectively cancels out the overall noise. Hence, active noise cancellation involves a dynamic process of generating opposing signals to cancel out unwanted noise.

In general, ANC can involve two distinct techniques, feedforward and feedback methods, which can be deployed independently or simultaneously. In the feedforward method, at least one microphone is positioned outside of an earcup to capture the surrounding noise. This captured noise signal is then utilized to drive the speaker and generate a counteracting signal. It is noted that such an external microphone typically does not capture the audio being played inside the earcup, and is focused solely on the noise from the external environment.

On the other hand, the feedback method involves placing a microphone inside an earcup. This internal microphone captures both the residual noise that penetrates the passive layer and the audio being played inside the earcup. This captured noise is then used to generate a counteracting signal to cancel out the unwanted noise effectively.

The combination of these two methods can provide a powerful and flexible improvement to passive noise cancellation.

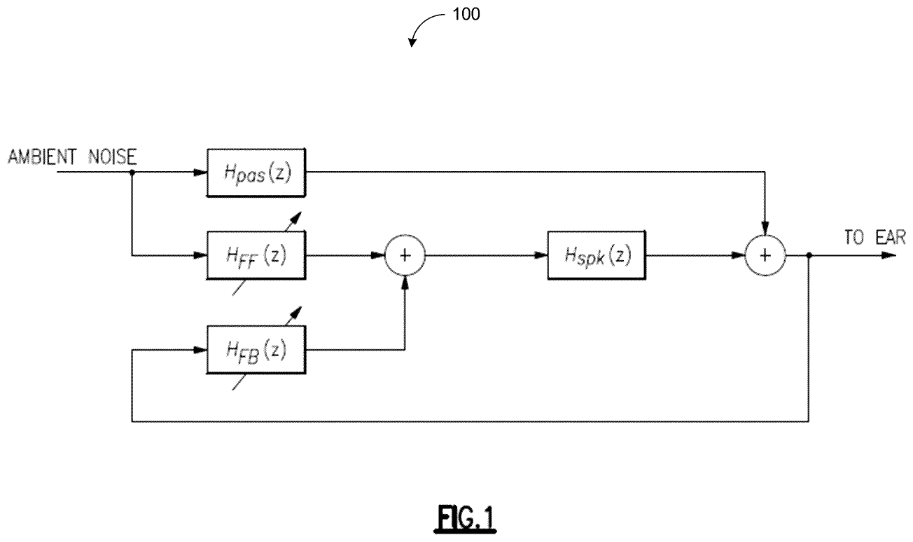

A mathematical or mathematic-based model can be provided for the background noise problem. FIG. 1 shows a diagram of an ANC system 100 incorporating passive (pas), feedforward (FF), and feedback (FB) paths that can be included in, for example, a headphone. In FIG. 1, Hₚₐₛ(z) represent a passive acoustic transfer function of the headphone; Hₛₚₖ(z) represents an acoustic transfer function of the speaker driver; and H_{FF}(z) and H_{FB}(z) represent feedforward and feedback ANC filters, respectively. The input to this model represents the surrounding noise (indicated as ambient noise in FIG. 1).

As an example, one can adopt linear time-invariant (LTI) systems to model passive components and speakers associated with the ANC system 100 of FIG. 1. However, it is noted that in real-world scenarios, each of these elements may not remain time-invariant due to factors such as fit quality or user movement, and speakers may exhibit nonlinear behavior for certain volume and frequency inputs. Despite these complexities, the use of LTI systems can provide a framework for analysis and algorithm implementations.

Furthermore, one can introduce two additional LTI systems to represent the feedforward and feedback components. The model's output reflects what is received at the ear, and an objective of ANC is to optimize the parameters of the feedforward and feedback components to minimize the impact of noise on the output signal.

Mathematically, the foregoing optimization problem can be formulated as a minimization task, where an objective function quantifies the discrepancy between a desired output (e.g., the input audio signal) and an actual output received at the ear. By adjusting the parameters of the feedforward and feedback paths, ANC can be configured to minimize this discrepancy, effectively canceling out some or all of the unwanted noise and enhancing the clarity of the desired audio signal.

Described herein are examples of how classical methods have traditionally been employed to tackle this problem, including their inherent limitations. Also described herein are examples of systems, devices and methods where deep neural networks (DNNs) can be implemented in addressing some or all of these challenges.

It some implementations, DNNs can provide an advantageous functionality for noise cancellation due to their ability to learn complex patterns and relationships directly from data; and such a capability of DNNs can be utilized to overcome some or all of the shortcomings of classical methods. Provided herein are examples related to applications of DNNs in ANC systems, and their advantages and design considerations in comparison to traditional approaches.

As mentioned above, there are two main ways of generating an anti-noise signal for purposes of ANC: feed-forward (FF) ANC filter, and feedback (FB) ANC filter.

In some implementations, the foregoing feed-forward ANC filter generates anti-noise by filtering signals from one or more external microphones, which act as references to the ambient noise. An objective of the filter is to output a stimulus that, when played through the speaker, produces the negative of the ambient noise coupling in the user's ear. Referring to the example of FIG. 1, such an objective could be achieved to a reasonable degree if

$${H}_{F F} ( z ) \approx - \frac{{H}_{p a s} ( z )}{{H}_{s p k} ( z )} . \qquad ( 1 )$$

Thus, one way of designing the FF ANC filter is by estimating the acoustic parameters Hₚₐₛ(z) and Hₛₚₖ(z), and creating a filter H_{FF}(z) that approximates the negative of their ratio. For example, MATLAB's invfreqz function can be utilized to design a filter that approximates a given transfer function. It is noted that the FF ANC filter can use either a finite impulse response (FIR) or infinite impulse response (IIR) structure.

The feedback ANC filter acts on a signal from a microphone placed between the speaker and the ear canal. This signal provides a reference to the net acoustic signal going to the ear. The output of the FB ANC filter forms a part of the stimulus driving the speaker. Thus, it creates a feedback loop that includes the FB ANC filter and the speaker driver. Ignoring the contribution of FF ANC, a noise transfer function (NTF) due to FB ANC can be given by

$$N T {F}_{F B} ( z ) = {H}_{p a s} ( z ) \frac{1}{1 - {H}_{F B} ( z ) {H}_{s p k} ( z )} . \qquad ( 2 )$$

An objective of the FB ANC filter is to achieve a small value for

$$\frac{1}{1 - {H}_{F B} ( z ) {H}_{s p k} ( z )}$$

in audible band, while keeping the feedback loop stable.

It is noted that FF ANC and FB ANC can coexist, and such a combination is referred to as a hybrid ANC.

In many applications, acoustic transfer functions such as the above-mentioned transfer functions Hₚₐₛ(z) and Hₛₚₖ(z) can vary over time, among manufactured units, and/or among different users. Thus, a single ANC filter design may not be optimal for all use cases.

The foregoing variability of acoustic transfer functions presents a need for or desirability of adaptive ANC filters. Ways of adapting ANC filters can include a first example technique involving acoustic parameter estimation. In such a technique, acoustic parameters can be re-estimated at periodic intervals or when a change is detected. Once a new set of acoustic parameters is available, the corresponding ANC filters can be reconfigured.

In a second example technique of adapting ANC filters can include output-error minimization methods. In such a technique, filtered-x least-mean-square (FxLMS) methods can be utilized to adapt FF ANC filters that have FIR structures.

It is noted that there are a number factors that pose significant challenges for an effective ANC filter design. For example, variation in acoustic properties can pose a challenge. As mentioned above, acoustic transfer functions such as Hₚₐₛ(z) and Hₛₚₖ(z) can vary due to manufacturing tolerances as well as changes in user fit during regular use. It is desirable to have ANC filters adapt accordingly, without any objectionable transient effects, to be effective.

In another example, use of headphones can pose many transitional situations (corner cases) where acoustic parameters are atypical. Such situations can include, for example, putting on the headphones, inertial movements, and disturbances caused by intentional and unintentional user interactions.

In yet another example, it is desirable to have stability of FB ANC be provided across the various expected use cases and unexpected corner cases.

In yet another example, signal limiting can involve a situation where a speaker stimulus generated by ANC filters might exceed the input dynamic range of the headphone amplifier or speaker driver. Such an effect can result in non-linearity which can undermine ANC performance.

In some implementations, the present disclosure relates to utilization of one or more deep neural networks (DNNs) to address some or all of the challenges described above.

In some embodiments, one can characterize an ANC model to include four components, all assumed to be linear and time-invariant. In some embodiments, and as also described herein, techniques to handle nonlinearity and/or time variance can be implemented.

In some embodiments, two of the four components, namely Hₚₐₛ and Hₛₚₖ, can be considered fixed and can be modeled as infinite impulse response (IIR) filters with known estimated parameters. The remaining components, namely FF and FB filters, can represent configurations that can be determined or estimated as described herein.

In some embodiments, one can treat both FF and FB as IIR filters and utilize DNNs to find their parameters. This approach, termed herein as ‘IIR-Based DNN,’ can leverage the classical IIR structure for FF and FB, thereby allowing one to capitalize on the benefits of DNN methods, including multi-criteria optimization and systematic adaptation. During deployment, one can utilize available hardware resources to implement ANC efficiently.

Alternatively, in some embodiments, one can relax this constraint and view FF and FB as DNNs with recurrent structures. These networks, termed herein as ‘Recurrent DNN Paradigm,’ can receive input samples and output samples, featuring a flexible internal state structure with possible nonlinearities and mechanisms such as long short-term memory (LSTM) and backpropagation through time. This method can provide greater flexibility and can handle complex scenarios more effectively. Implementation of this method can involve a specialized ANC engine to execute.

Described herein are more specific examples related to each of the foregoing two approaches. For each approach, its theoretical underpinnings, implementation methodologies, and practical considerations are discussed. Through empirical evaluation and comparative analysis, one can show the strengths and limitations of each approach, thereby providing one or more improved features in ANC technology.

In some implementations, the present disclosure relates to utilization of one or more deep neural networks (DNNs) such that infinite impulse response (IIR) filters can be framed into well-defined building blocks of neural networks. Without loss of generality, one can represent an IIR as a combination of second-order sections (SOS), each representing a distinct filter stage. Mathematically, this can be expressed as:

$$H ( z ) = g {\prod }_{j = 1}^{N} {B}_{j} ( z ) = g {\prod }_{i = 1}^{N} \frac{1 + {b}_{1 , j} {z}^{- 1} + {b}_{2 j} {z}^{- 2}}{1 + {a}_{1 , j} {z}^{- 1} + {a}_{2 , j} {z}^{- 2}} , \qquad ( 3 )$$

where g represents the gain term, b_{i,j} represents the feedforward coefficients, and a_{i,j} represents the feedback coefficients of each second-order section. Each second-order section corresponds to a normalized biquad. Here, one can assume that b₀ is nonzero, which is not the most general form but is commonly employed in practical situations. Value of b₀ equaling zero is equivalent to a filter having a pure delay of one sample, and hence is generally undesirable in ANC filters. Hence, this assumption does not pose any performance limitation and reduces the degrees of freedom, which is beneficial for optimization purposes.

Since the normalized biquad serves as a fundamental unit for the IIR, one can note its significance. Both the direct and transposed realizations of a biquad can be viewed as special cases of recurrent neural networks. More specifically, one can consider them as special cases of recurrent neural networks without nonlinearity and with special constraints between the hidden state and input to update the input and hidden state. Due to its stability, in some embodiments, transposed direct form-II (DF2T) technique can be implemented.

In some embodiments, the following set of equations can represent the recursive update equations for the normalized biquad:

$$y [ n ] = x [ n ] + {h}_{1} [ n - 1 ] ; \qquad ( 4 a )$$

$${h}_{1} [ n ] = {b}_{1} x [ n ] + {h}_{2} [ n - 1 ] - {a}_{1} y [ n ] ; and \qquad ( 4 b )$$

$${h}_{2} [ n ] = {b}_{2} x [ n ] - {a}_{2} y [ n ] . \qquad ( 4 c )$$

$$h [ n ] = [ \begin{matrix}{h}_{1} [ n ] \\ {h}_{2} [ n ]\end{matrix} ]$$

Here x[n] is the input sample, is the hidden state, and y[n] is the output sample. With some manipulation, one can demonstrate that a transposed direct form-II biquad is equivalent to a recurrent cell block in the DNN domain, as follows:

$$y [ n ] = {W}_{y x} x [ n ] + {W}_{y h} h [ n ] , and \qquad ( 5 a )$$

$$h [ n ] = {W}_{h x} x [ n ] + {W}_{h h} h [ n ] . \qquad ( 5 b )$$

$$where , {W}_{y x} = 1 , {W}_{y h} = [ \begin{matrix}1 & 0\end{matrix} ] , {W}_{h x} = [ \begin{matrix}{b}_{1} - {a}_{1} \\ {b}_{2} - {a}_{2}\end{matrix} ] , and {W}_{h h} = [ \begin{matrix}- {a}_{1} & 1 \\ - {a}_{2} & 0\end{matrix} ] .$$

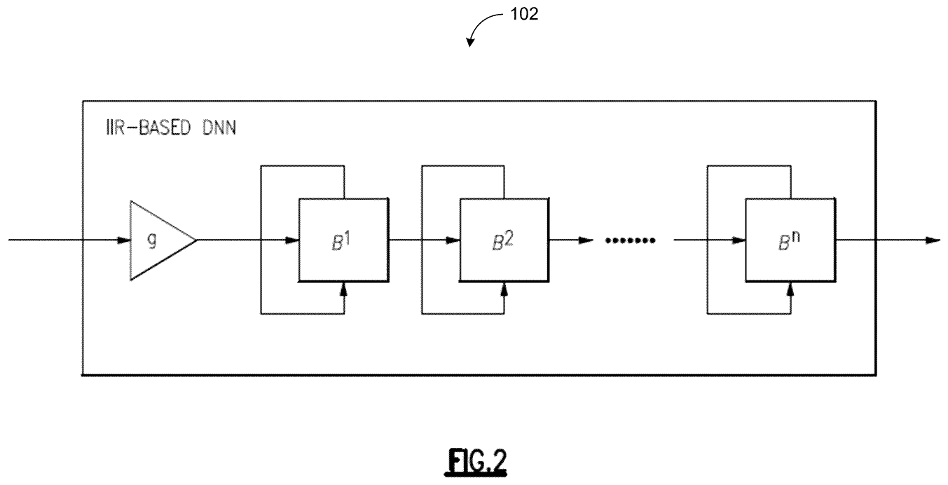

As mentioned above, each biquad can be represented as a special RNN cell with linear activation and structured matrix form. One can then cascade a number of these cells together and add a scalar parameter to construct an IIR filter, as shown as an example in FIG. 2 which is a representation of second order sections implemented as a cascaded recurrent neural network 102 with linear activation.

The foregoing configuration can provide an important role in an ANC model as described herein. For both the IIR-Based DNN and the Recurrent DNN Paradigm, one can employ this framework to model Hₚₐₛ and Hₛₚₖ, where the parameters are known and non-trainable. However, this model can still provide a backpropagation-friendly way to represent them. In the case of the IIR-Based DNN, one can also utilize H_{FF} and H_{BF} as DNN models for IIR, where they have some trainable parameters. In contrast, for the Recurrent DNN Paradigm, H_{FF} and H_{BF} can virtually be any neural network. It is noted that a notable benefit of these methods includes a feature where they provide a gradient-friendly approach for solving the ANC problem.

In some implementations, one or more deep neural networks (DNNs) can be utilized for estimating infinite impulse response (IIR) in active noise cancellation (ANC) applications. In some embodiments, such a novel application of DNNs can include expressing ANC within the framework of neural networks, which allows implementations of new techniques that provide improved ANC performance.

It is noted that in the ANC domain, estimating feedforward (FF) and feedback (FB) filters presents distinct challenges, each with its own set of complexities. As described herein, one or more features as described herein can address some or all of such challenges.

In some embodiments, a framework of one or more neural networks can be configured to provide estimation of either or both of feedforward (FF) and feedback (FB) filters. In some embodiments, a framework of one or more neural networks can be configured to provide estimation of feedback (FB) filters; however, such estimation with DNN training strategies can involve special design considerations to ensure stability of the feedback loop.

In some embodiments, a framework of one or more neural networks can be configured to provide estimation of feedforward (FF) filters alone. It is noted that estimating FF filters presents unique challenges; however, one or more features as described herein related to utilizing DNN training techniques can facilitate such estimation of FF filters. Utilization of such DNN framework to estimate FF filters can allow leveraging its capabilities to address the challenges associated with ANC systems. Thus, in some embodiments, an ANC system as described herein either does not incorporate FB filters, or if it does, they have been properly designed and remain fixed.

Utilizing the above-mentioned framework of neural networks, one can estimate an optimal or desired IIR filter for ANC systems. In some embodiments, such a technique can include utilization of DNN training to find the most or sufficiently effective FF parameters given the constraints of a given ANC setup.

In some embodiments, alternative neural network architectures can be utilized for FF estimation. By such use of one or more various network structures, one can determine the most or sufficiently suitable model for capturing the complex dynamics of ANC systems.

As described herein, a framework of neural networks can be utilized for estimation of FF filters. In some embodiments, such a framework can be further configured to provide estimation of feedback (FB) filters, which presents its own set of challenges. Such challenges associated with estimating FB filters can include ensuring stability, since FB filters involve a feedback loop in the ANC system.

To address the foregoing stability challenge, one can implement several strategies to provide stability in the FB estimation process. It is noted that traditional neural networks often struggle with stability issues in feedback loops, as they may diverge over time. However, in some embodiments, use of proper constraints, selected initialization techniques, and/or customized training strategies can be implemented to develop neural network architectures that maintain stability even in the presence of feedback loops.

It is noted that the foregoing approach represents a unique aspect of ANC techniques. More particularly, an estimation of stable FB filters using neural networks can provide a significant advancement in the field of ANC. By overcoming the stability challenges associated with FB estimation, more practical and effective ANC systems that incorporate both FF and FB filters can be implemented.

In some implementations, the present disclosure relates to a technique that can combine estimation of FF and FB filters simultaneously. Traditionally, FF and FB filters are estimated separately, each with its own set of parameters and optimization process. However, it is noted that combining these two estimations into a unified framework can yield more effective and efficient ANC systems.

In some embodiments, techniques such as alternating estimation or fine-tuning can be utilized to achieve this goal. Alternating estimation involves iteratively estimating FF and FB filters while updating each other's parameters to reach a more optimal solution. On the other hand, fine-tuning involves refining the parameters of both FF and FB filters together after initial estimation to further improve their performance.

With utilization of some or all of the foregoing techniques, once can develop a unified approach to ANC filter estimation that includes consideration of interplay between FF and FB filters. Such an approach represents another avenue for enhancing the effectiveness and robustness of ANC systems.

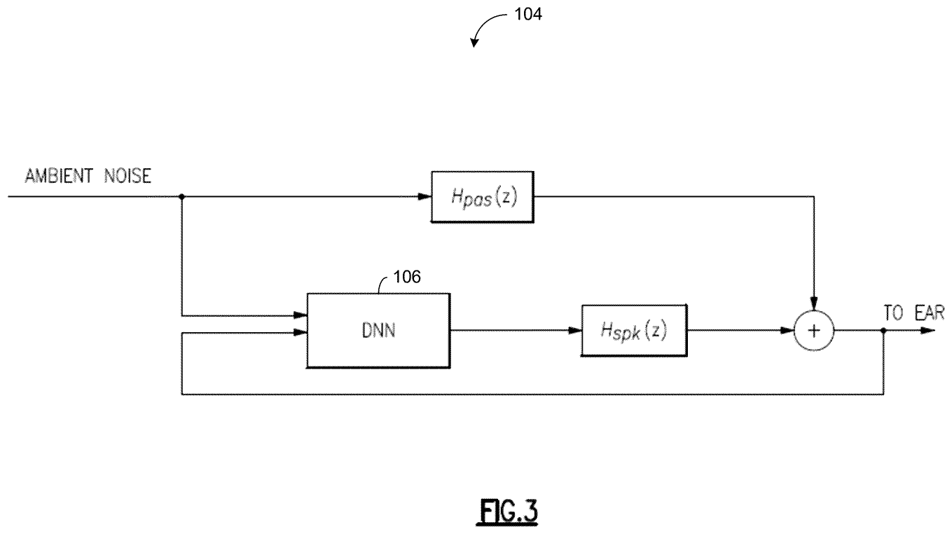

FIG. 3 shows an ANC architecture 104 that can be implemented with the foregoing technique where combined estimation of FF and FB filters are achieved simultaneously. With such a functionality, the ANC architecture 104 of FIG. 3 can include a single DNN 106 to jointly act as and/or configure feedforward (FF) and feedback (FB) filters.

In some implementations, the present disclosure relates to a technique where nonlinearity is introduced into an ANC model. It is noted that while modeling speakers as linear systems is a common practice, it may not fully capture the complexities of real-world applications. By incorporating nonlinear elements into an ANC model, one can better emulate the behavior of real-world speakers and address the limitations of linear modeling.

In some embodiments, implementation of the foregoing technique can allow ANC models to move beyond traditional linear models and integrate nonlinear elements into an ANC framework. Such a framework can provide enhancement of the accuracy and realism of ANC systems, thereby improving their performance in real-world scenarios.

In some implementations, the present disclosure relates to a technique where time-varying component(s) is/are incorporated into an ANC model. It is noted that headsets often contain components that may change over time, such as wear and tear on ear pads or variations in speaker performance. By emulating these factors in a model, one can better simulate real-world conditions and optimize ANC performance accordingly.

In some embodiments, and as described herein, Hₚₐₛ and Hₛₚₖ can be modeled as linear time-invariant (LTI) systems. In some embodiments, a framework of neural networks can be configured to accommodate some or all of time-varying characteristics associated with an ANC model. Such a technique can involve extending ANC models to account for variations in these components over time, allowing for more robust and adaptable ANC systems.

Moreover, one can also consider variations that may arise from factors unique to individual users. Different users may have different preferences, ear shapes, or hearing abilities, which can impact the performance of ANC systems. By incorporating user-specific variations into an ANC model, ANC algorithms can be tailored to better suit the needs or preferences of individual users.

It is noted that the foregoing approach not only enhances the realism of the corresponding ANC model but also improves its effectiveness in real-world scenarios. By addressing both time-varying factors and user-specific variations, one can develop ANC systems that offer optimal performance and comfort for a wide range of users.

In some implementations, the present disclosure relates to a technique related to customization of ANC behavior to adapt to different situations. Traditional ANC systems typically aim to reduce overall noise levels indiscriminately. However, there may be scenarios where certain types of noise are more important or distracting than others. In some embodiments, an ANC framework can be tuned to prioritize different types of noise according to situational requirements or conditions. For example ANC algorithms can be configured to provide such tuning functionality. In some embodiments, such tuning can include assigning different levels of importance to various noise sources and optimizing ANC performance accordingly.

As described herein, an ANC technique can include estimating Hₚₐₛ and Hₛₚₖ and utilizing these estimates to inform an ANC model. In some implementations, the present disclosure relates to a technique that goes beyond such a methodology.

For example, a technique can include incorporating a real-world interaction into a training process. In some embodiments, this could involve training an ANC system by interacting directly with actual devices in various environments. By collecting data from real-world scenarios, ANC algorithms can be fine-tuned to better adapt to practical conditions and user preferences.

Another approach is to leverage signals from a device itself, with or without ANC activated. This could involve utilizing off-policy learning techniques, such as reinforcement learning (RL), to train the ANC system based on historical data collected from the device. By learning from past interactions, the ANC system can improve its performance and adaptability over time.

In some embodiments, an ANC system having one or more features can include an ANC computation engine. It is noted that for good ANC performance, it is desirable to have the latency from microphone signal to the headphone output be small, preferably less than 10 μs. This requirement or preference provides certain design considerations for the ANC computation engine.

For example, an input sampling period needs to be small. In some embodiments, such a small sampling period can be achieved with high sample rates (e.g., ranges from 100s of kHz to a few MHz).

In another example, outputs can be generated sample-by-sample, as opposed to a frame/buffer/group of samples.

In yet another example, hardware engines with DSPs can be tailored for generating anti-noise signals. Such a hardware ANC engine can be configured to be capable of implementing biquad filters for FF and/or FB ANC filters. In some embodiments, the hardware ANC engine can be configured such that some or all of biquad coefficients are programmable. In some embodiments, the hardware ANC engine can be configured to support programmable signal graphs. In some embodiments, the hardware ANC engine can be configured to support adaptive FIR filters.

In some embodiments, some or all of the foregoing ANC engine functionalities can be implemented in a realtime acoustic processor (RAP) ANC engine. In some embodiments, such a RAP ANC engine can be implemented as a part of a system-on-chip (SoC) such as a headset SoC.

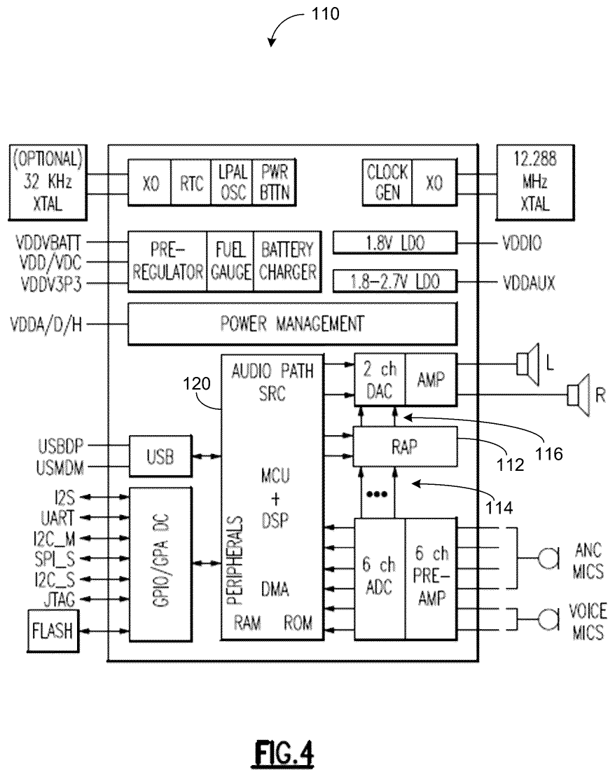

For example, FIG. 4 shows an example of a headset SoC 110, where an RAP engine 112 can be configured to provide some or all of the realtime audio processing as described herein. It is noted that the example SoC 110 of FIG. 4 is configured for headset applications; however, it will be understood that one or more features of the present disclosure can also be implemented in other types of SoCs.

Referring to the example of FIG. 4, it is noted that the RAP engine 112 has access to microphone samples 114 at a raw sampling rate and can inject an anti-noise signal 116 into a signal driving the headphones. In the same SoC 110, an MCU 120 can perform, for example, control, configuration, and programming tasks for the RAP engine 112, while the RAP engine handles the biquad filter load.

FIG. 5 shows a block diagram of an architecture 140 that can be implemented in the RAP engine 112 of FIG. 4. In some embodiments, such an RAP architecture can include a biquad and multiply-accumulate engine (indicated as MAC engine 142). Such a MAC engine can be configured to perform biquad filter and MAC computations efficiently.

In some embodiments, operation of the biquad and MAC engine can be controlled on a per clock cycle basis by a control and configuration unit 144.

In some embodiments, RAP processing can also include some nonlinear elements. For example, a compressor 146 can be provided to guarantee the RAP output does not exceed an input dynamic range of the speaker amplifier. Its design can be important and challenging since due to its direct effects on the ANC performance. In another example, an up/down ramping unit 148 can be provided to enable soft start/stop of ANC processing.

In some embodiments, an ANC computation engine such as the ANC engine 140 of FIGS. 4 and 5 can be configured to support DNN-based ANC computations. For example, such DNN-based computations can include some or all of matrix multiplication, convolution layers, RNN inference, and nonlinearities (e.g., tanh).

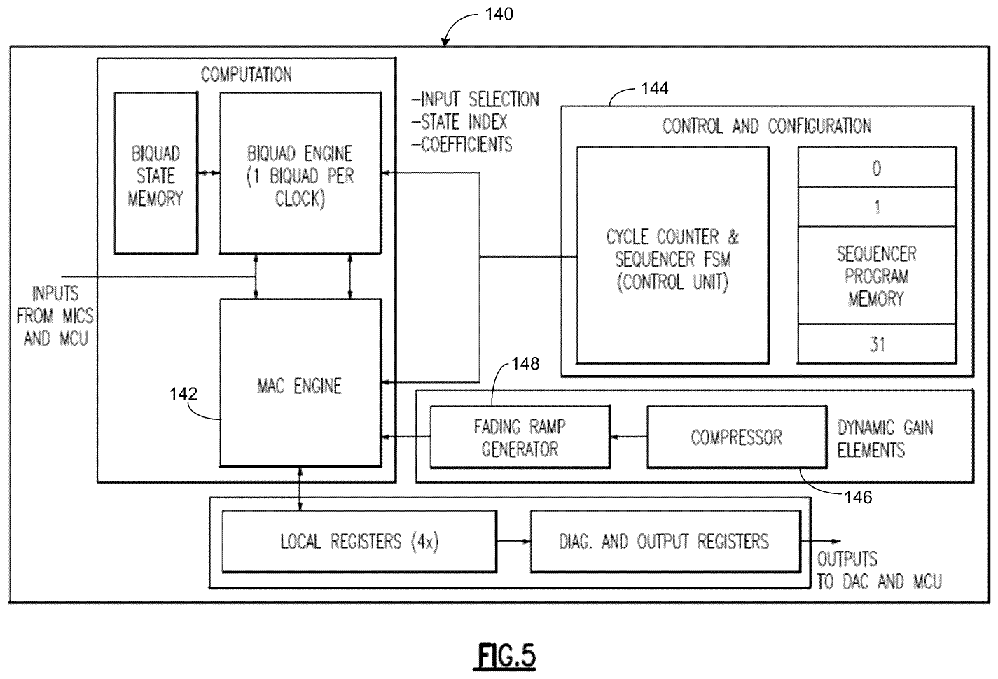

FIG. 6 shows a result of an experiment performed where a DNN framework as described herein was utilized. In the experiment, such a DNN framework was utilized to approximate the feedback filters. It was assumed that the speaker is perfectly linear, and the DNN framework-based results are compared with a carefully hand-designed filter.

For this experiment, two real measured transfer functions were used for passive noise cancellation and speaker driver. To measure the performance of the DNN-based method, the system, including Hpas and Hspk, and the estimated FB filter, was put into a Simulink model. Brown noise was provided as an input to the system and the noise that reaches the ear was measured.

FIG. 6 shows spectra of noise associated with input noise, passive cancellation, ANC using the manually designed FB filter, and ANC with DNN-based FB filter. As shown in this figure, the DNN-based FB filter outperforms the manually designed filter.

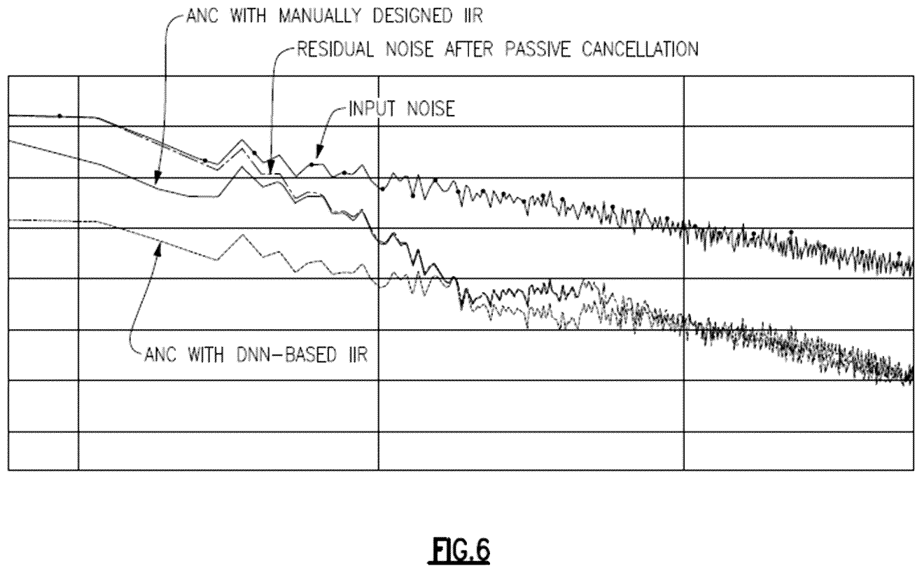

FIG. 7 shows the root mean square (RMS) of the received noise at the ear (10 to 20 kHz) for the manually designed FB filter and the DNN-based FB filter. This figure demonstrates that the DNN-based approach as described herein can generate a filter with stable closed-loop properties.

In the example of FIG. 7, the speaker is assumed to be linear for a broad range of inputs, which may not be practical in some situations. However, the ANC-based technique's efficacy in approximating feedback filters and its ability to generate stable closed-loop solutions is demonstrated.

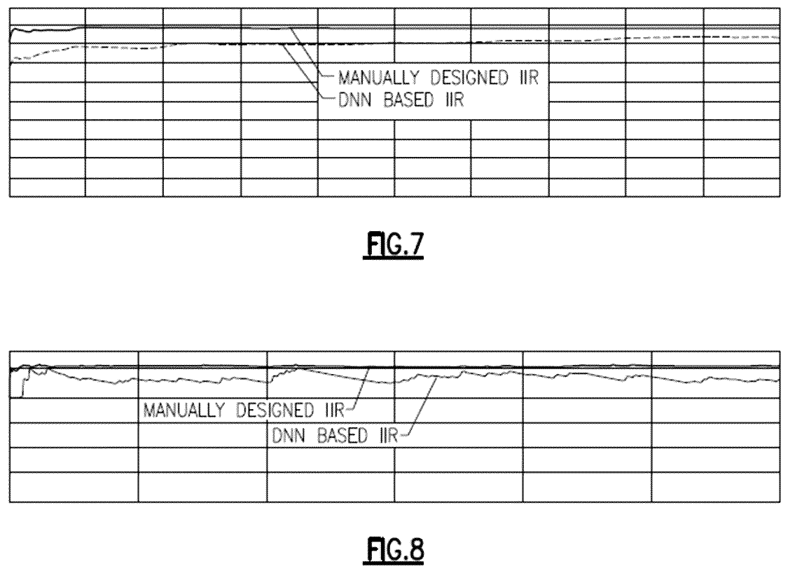

FIG. 8 shows a result of an experiment where a DNN-based framework was utilized to approximate the feedback (FB) filter when the speaker exhibits nonlinearity. In this scenario, the ANC system had the FB filter structured as second-order sections (SOS), with no feedforward (FF) component. To simulate the nonlinear behavior of the speaker, a tanh function is employed to mimic the saturation effects observed in practical speaker systems.

For training this model, white noise was provided as an input signal, with a batch size of 512 samples and an input length of 128 samples. An Adam optimizer with a learning rate of 1e-6 was utilized. The model was initialized with coefficients obtained from classical methods, and the root mean square (RMS) was minimized during training.

In FIG. 8, RMS of received noise at the ear (10 to 20 kHz) for a manually designed FB and DNN-based FB (Blue) with speaker nonlinearity are shown. Such results show that by leveraging the DNN framework, classical filter can be fine-tuned to achieve approximately-3 dB higher noise reduction compared to its original performance.

It is noted that while this experiment demonstrates the capability of a DNN-based model to design filters in the presence of nonlinearity, it represents an example scenario and does not encompass all criteria typically used to evaluate filter quality. Nevertheless, these results demonstrate that a DNN-based model's approach is capable of effectively addressing one or more challenges posed by nonlinear speaker behavior.

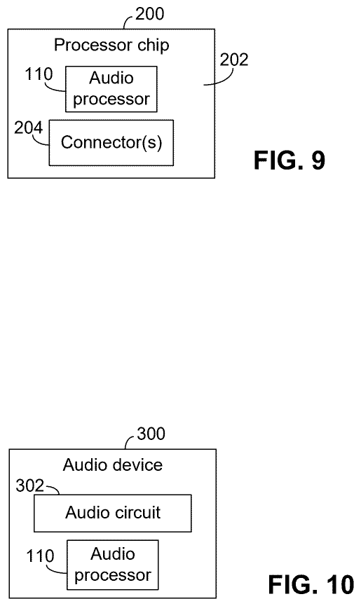

FIG. 9 shows that in some embodiments, an audio processor, such as the audio processor 110 of FIG. 4, having one or more features as described herein can be implemented on a chip 200. In some embodiments, such a chip can be a semiconductor die, a packaged module, or some combination thereof.

For example, if the chip 200 is implemented as a semiconductor die, such a die can include a semiconductor substrate 202, and some or all of the audio processor 110 can be implemented on the substrate 202.

In another example, if the chip 200 is implemented as a packaged module, such a module can include a packaging substrate 202, and some or all of the audio processor 110 can be implemented on one or more die that is/are mounted on the packaging substrate 202.

In the example of FIG. 9, the chip 200 is also shown to include connector(s) 204 configured to provide connections for the audio processor 110.

FIG. 10 shows that in some embodiments, an audio processor 110 having one or more features as described herein can be included in an audio device 300. Such an audio device is shown to also include an audio circuit 302 that can be configured to operate with the audio processor 110. In some embodiments, the audio device 300 can be a wireless device, wired device, or some combination thereof, and can include, for example, a headset, an earbud, a soundbar or any device that generates sound based on an electrical signal.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. An active noise cancellation system comprising:
an input node for receiving a noise signal;
an output node for providing an anti-noise signal; and
one or more blocks each configured to provide a transfer function between its input and output, the block further configured to be capable of having its transfer function estimated by a deep neural network framework.

2. The active noise cancellation system of claim 1 wherein each block includes a filter.

3. The active noise cancellation system of claim 2 wherein the filter is configured as a finite impulse response filter or an infinite impulse response filter.

4. The active noise cancellation system of claim 1 wherein the block includes a feedforward block.

5. The active noise cancellation system of claim 1 wherein the block includes a feedback block.

6. The active noise cancellation system of claim 5 wherein the transfer function of the feedback block is estimated based on linear and ideal speaker conditions.

7. The active noise cancellation system of claim 5 wherein the transfer function of the feedback block is estimated with a condition including nonlinearity in a signal path.

8. The active noise cancellation system of claim 1 wherein the one or more blocks include a feedforward block and a feedback block.

9. The active noise cancellation system of claim 8 wherein each of the feedforward and feedback blocks has its transfer function estimated by a separate deep neural network framework.

10. The active noise cancellation system of claim 8 wherein the feedforward and feedback blocks have their transfer functions estimated by a common deep neural network framework.

11. The active noise cancellation system of claim 1 further comprising a computation engine configured to support the deep neural network framework.

12. The active noise cancellation system of claim 11 wherein the computation engine includes a biquad engine configured to perform biquad filter computations.

13. The active noise cancellation system of claim 11 wherein the computation engine includes a multiply-accumulate engine configured to perform multiply-accumulate computations.

14. The active noise cancellation system of claim 11 wherein the computation engine is part of a system-on-chip device.

15. The active noise cancellation system of claim 14 wherein the system-on-chip device further includes a digital signal processing circuit that includes the one or more blocks.

16. A chip comprising:
a substrate; and
an active noise cancellation circuit implemented on the substrate, the active noise cancellation circuit including an input node for receiving a noise signal, and an output node for providing an anti-noise signal, the active noise cancellation circuit further including one or more blocks each configured to provide a transfer function between its input and output, the block further configured to be capable of having its transfer function estimated by a deep neural network framework.

17. The chip of claim 16 wherein the chip is configured as a system-on-chip.

18. The chip of claim 17 wherein the system-on-chip further includes a computation engine configured to support the deep neural network framework.

19. The chip of claim 18 wherein the system-on-chip device further includes a digital signal processing circuit that includes the one or more blocks.

20. An audio device comprising:
an input circuit for receiving an input signal;
a speaker for producing sound waves based on an output signal corresponding to the input signal;
an audio circuit configured to process the electrical signal and generate the output signal; and
an active noise cancellation circuit including an input node for receiving a noise signal, and an output node for providing an anti-noise signal, the active noise cancellation circuit further including one or more blocks each configured to provide a transfer function between its input and output, the block further configured to be capable of having its transfer function estimated by a deep neural network framework.

21. (canceled)

22. (canceled)

23. (canceled)

24. (canceled)

25. (canceled)

26. (canceled)
